(19) United States
(12) Patent Application Publication
(10) Pub. No.: US 2019/0060917 A1
(43) Pub. Date: Feb. 28, 2019

(54) CENTRIFUGAL FILTER

(71) Applicant: LIS AUTOMATIC CONTROLLED CO., LTD., Taichung City (TW)

(72) Inventor: Chieh-Ming CHANG, Taichung City (TW)

(21) Appl. No.: 16/119,383

(22) Filed: Aug. 31, 2018

(30) Foreign Application Priority Data
Aug. 31, 2017 (TW) 106129693

(51) Int. Cl. B04C 5/06; B04C 5/12; B04C 5/14; C02F 1/38

(52) U.S. Cl. CPC B04C 5/06; B04C 5/12; B23Q 11/10; C02F 1/38; B04C 5/14

(57) ABSTRACT

A centrifugal filter comprises a top flow guiding assembly, a water inlet flow guiding assembly, a recessed flow guiding assembly, and an impurity flow guiding assembly, in which a liquid entering from a water inlet opening of the water inlet flow guiding assembly can generate a convolution in an inner portion of the recessed flow guiding assembly. After convoluting to a bottom portion of the recessed flow guiding assembly, heavier impurity components comprised by the liquid flows downwardly into the impurity flow guiding assembly, and the liquid without the impurity components convolutes upwardly. Finally, the top cover portion outwardly discharges the liquid without the impurity components.

### BACKGROUND OF THE INVENTION

### 1. Field of the Invention

The present invention relates to a centrifugal filter, particularly to a centrifugal filter capable of filtering shreds or other impurities in the liquid.

### 2. Descriptions of the Related Art

The high-pressure coolant feeder on the market mainly uses a pressure pump to output the coolant at a high pressure to the cutting area, and the rapid cooling and lubrication effects are achieved by the high-speed output coolant.

Moreover, the high-pressure output coolant may further effectively destroy the long coiled shreds in the wound shape, so that the long coiled shreds form smaller shreds so as to further prevent the long coiled shreds from being dragged between the processing cutting tool and the processed objects to influence the processing precision. Hence, the processing precision and efficiency can be greatly improved, and the service life of the processing cutting tool can be effectively extended.

However, when a cutting tool with a high cutting speed is used, the cutting tool cannot be sufficiently cooled or the shreds cannot be removed in time, so the cutting tool may be shaken due to the excessive pressure and flow, such that the processing precision is decreased or even the workpieces are caused to become unusable. Thus, the aforementioned coolant is very important. However, this type of coolant is used cyclically, so the coolant is likely to carry shreds or other impurities when the coolant is in operation. If the shreds or other impurities are not filtered, the motor (pump) may be damaged. Hence, how to effectively filter shreds or other impurities in the coolant will be a very important issue.

In addition, most of the common filter methods use filter paper to circulate in the motor (pump) to collect shreds or other impurities mixed in the coolant. However, the types of filter methods tend to cause blocking of the filter pores, so maintenance, such as replacing the filter paper, is required to be carried out at intervals. Furthermore, filter paper is discarded after used up, the disposal costs are also required. At the same time, many environmental problems may be caused as well.

Thus, it can be known that, if shreds or other impurities in the coolant can be filtered via a device before the coolant enters the motor, the motor can be prevented from being damaged by shreds and other impurities. This should be a best solution.

### SUMMARY OF THE INVENTION

The centrifugal filter can be achieved, the centrifugal filter at least comprising: a top flow guiding assembly having a top cover portion at a top portion, wherein the top cover portion downwardly forms a first screw connection column, and the first screw connection column downwardly forms a spiral flow guiding column, and a surface of the spiral flow guiding column has a plurality of spiral flow guiding grooves, and the top flow guiding assembly has a first through channel therein capable of passing through the top flow guiding assembly; a water inlet flow guiding assembly having a first screw connection portion at a top portion and capable of being screwingly connected to the first screw connection column, wherein the screw connection portion has a screw connection wall surface therein, and the screw connection portion downwardly has a water inlet portion, and a sidewall surface of the water inlet portion has a water inlet opening thereon capable of passing through an inner portion of the water inlet portion, wherein the water inlet portion downwardly forms a second screw connection column, and the water inlet flow guiding assembly has a second through channel therein capable of passing through the water inlet flow guiding assembly; a recessed flow guiding assembly having a second screw connection portion at a top end and capable of being screwingly connected to the second screw connection column, wherein a bottom end of the recessed flow guiding assembly has a third screw connection column, and an inner portion of the recessed flow guiding assembly has a third through channel capable of passing through the recessed flow guiding assembly, wherein the third through channel is a channel structure with a wider upper end and a narrower lower end; an impurity flow guiding assembly having a third screw connection portion at a top end and capable of being screwingly connected to the third screw connection column, wherein an inner portion of the impurity flow guiding assembly has a fourth through channel capable of passing through the impurity flow guiding assembly, wherein a liquid entering from the water inlet opening may convolute and move downwardly along the spiral flow guiding grooves into the third through channel, and a heavier impurity component comprised by the convoluting liquid flows downwardly into the fourth through channel due to the channel structure with the wider upper end and the narrower lower of the third through channel, and finally the top cover portion outwardly discharges the liquid without the impurity component after the liquid without impurity component passes the third through channel, the second through channel, and the first through channel from the bottom to the top.

More specifically, the bottom portion of the impurity flow guiding assembly may further be connected to at least one conduit and is configured to outwardly discharge the heavier impurity component comprised by the liquid through the conduit.

More specifically, the liquid entering from the water inlet opening may be injected in a high pressure manner, such that the liquid may convolute and move downwardly along the spiral flow guiding grooves into the third through channel.

More specifically, after the top flow guiding assembly is locked with the water inlet flow guiding assembly, the water inlet opening corresponds to positions of the spiral flow guiding grooves of the spiral flow guiding column, such that the liquid entering from the water inlet opening is guided by the spiral flow guiding grooves so as to convolute and move downwardly along the spiral flow guiding grooves into the third through channel.

### BRIEF DESCRIPTION OF THE DRAWINGS

FIG. 1A is a schematic exploded structure figure of a centrifugal filter of the present invention.

FIG. 1B is a schematic assembled structure figure of the centrifugal filter of the present invention.

FIG. 1C is a schematic cross-sectional structure figure after the assembling of the centrifugal filter of the present invention.

FIG. 2 is a schematic application implementation figure of the centrifugal filter of the present invention.

### DETAILED DESCRIPTION OF THE PREFERRED EMBODIMENTS

Other technical content, characteristics, and effects of the present invention will be clearly presented in the following detailed description of the preferred embodiments with reference to the drawings.

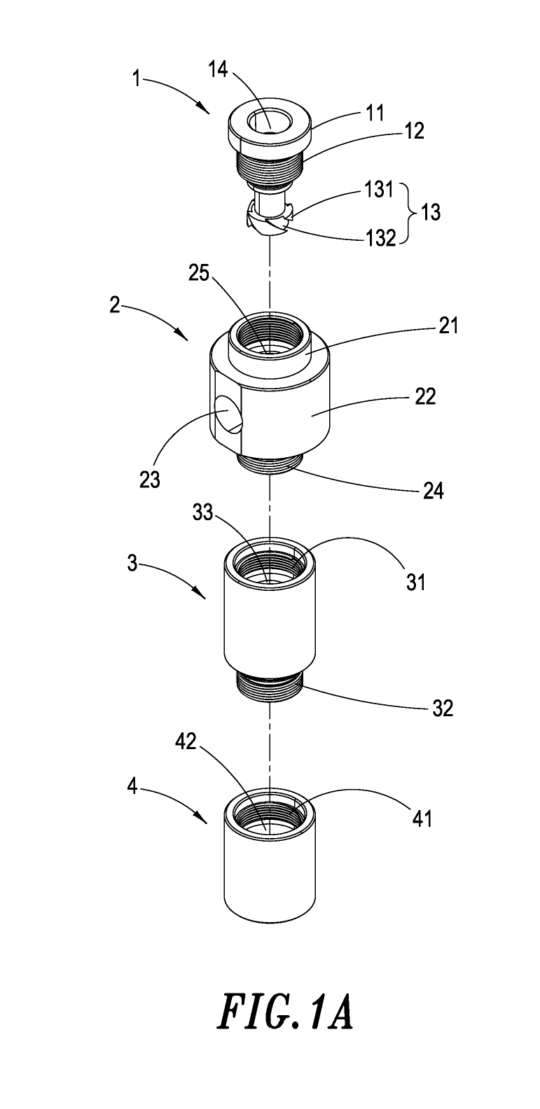

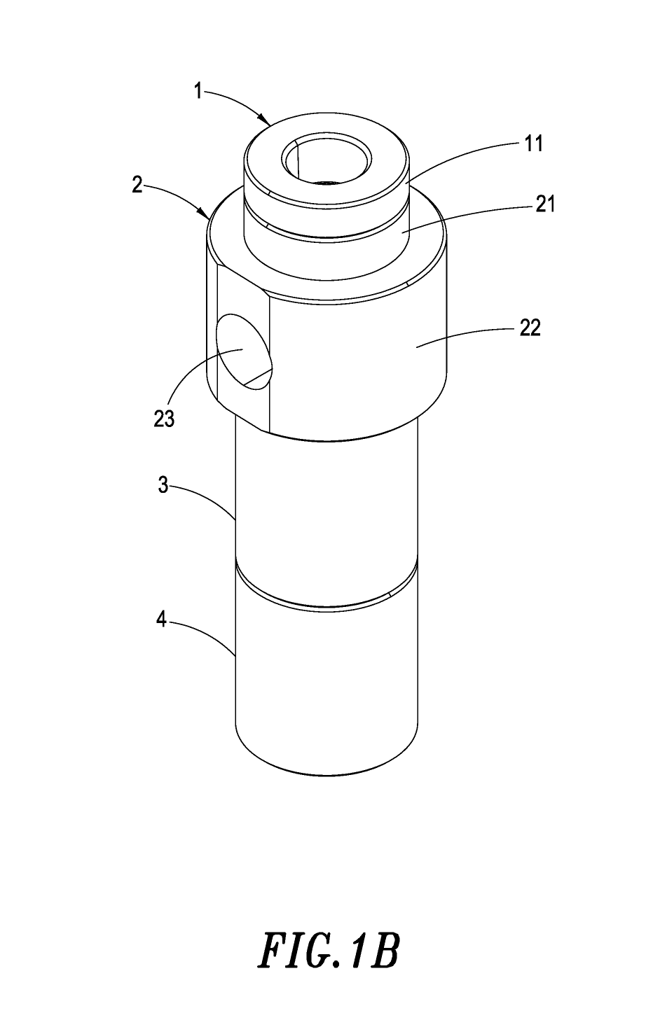

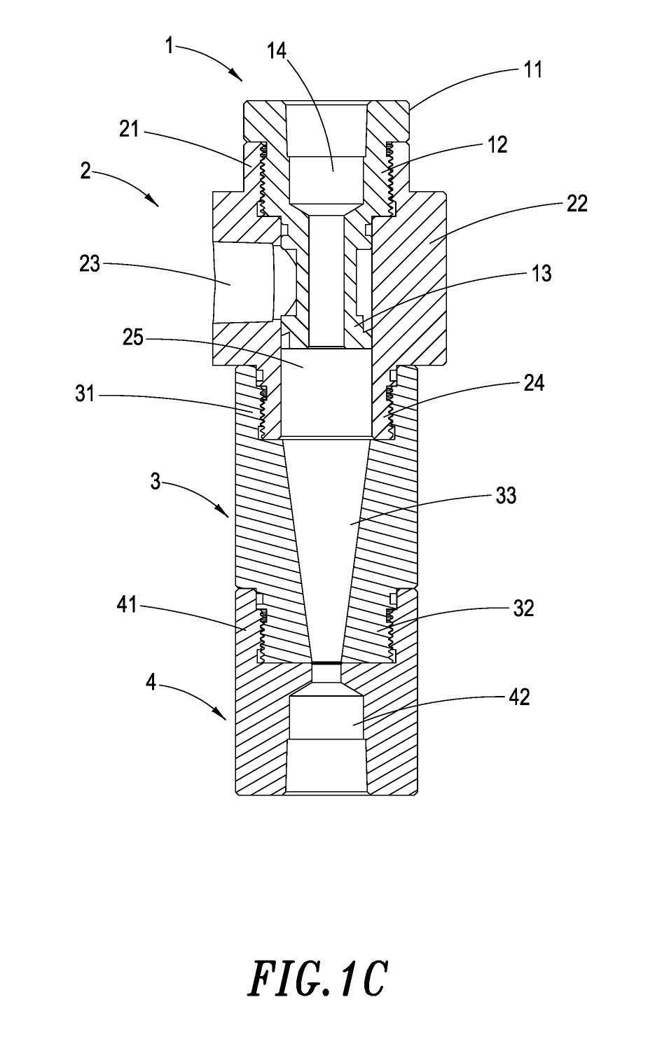

Please refer to FIGS. 1A to 1C, which are a schematic exploded structure figure, a schematic assembled structure figure, and a schematic cross-sectional structure figure after the assembling of a centrifugal filter of the present invention. It can be known from the figures that the centrifugal filter at least comprises a top flow guiding assembly 1, a water inlet flow guiding assembly 2, a recessed flow guiding assembly 3, and an impurity flow guiding assembly 4.

In the centrifugal filter, the top flow guiding assembly 1 has a top cover portion 11 at a top portion, wherein the top cover portion 11 downwardly forms a first screw connection column 12, and the first screw connection column 12 downwardly forms a spiral flow guiding column 13, and the surface of the spiral flow guiding column 13 has a plurality of tilted ribs 131, wherein the tilted ribs 131 may form a plurality of spiral flow guiding grooves 132, and the top flow guiding assembly 1 has a first through channel 14 therein capable of passing through the top flow guiding assembly 1.

In the centrifugal filter, the water inlet flow guiding assembly 2 has a first screw connection portion 21 at a top portion and capable of being screwingly connected to the first screw connection column 12, wherein the screw connection portion 21 has a screw connection wall surface 211 therein, and the screw connection portion 21 downwardly has a water inlet portion 22, and the sidewall surface of the water inlet portion 22 has a water inlet opening 23 thereon capable of passing through the inner portion of the water inlet portion 22, wherein the water inlet portion 22 downwardly forms a second screw connection column 24, and the water inlet flow guiding assembly 2 has a second through channel 25 therein capable of passing through the water inlet flow guiding assembly 2.

In the centrifugal filter, the recessed flow guiding assembly 3 has a second screw connection portion 31 at a top end and capable of being screwingly connected to the second screw connection column 24, and the bottom end of the recessed flow guiding assembly 3 has a third screw connection column 32, and the inner portion of the recessed flow guiding assembly 3 has a third through channel 33 capable of passing through the recessed flow guiding assembly 3, wherein the third through channel 33 is a channel structure with a wider upper end and a narrower lower end.

In the centrifugal filter, the impurity flow guiding assembly 4 has a third screw connection portion 41 at a top end and capable of being screwingly connected to the third screw connection column 32, and the inner portion of the impurity flow guiding assembly 4 has a fourth through channel 42 capable of passing through the impurity flow guiding assembly 4.

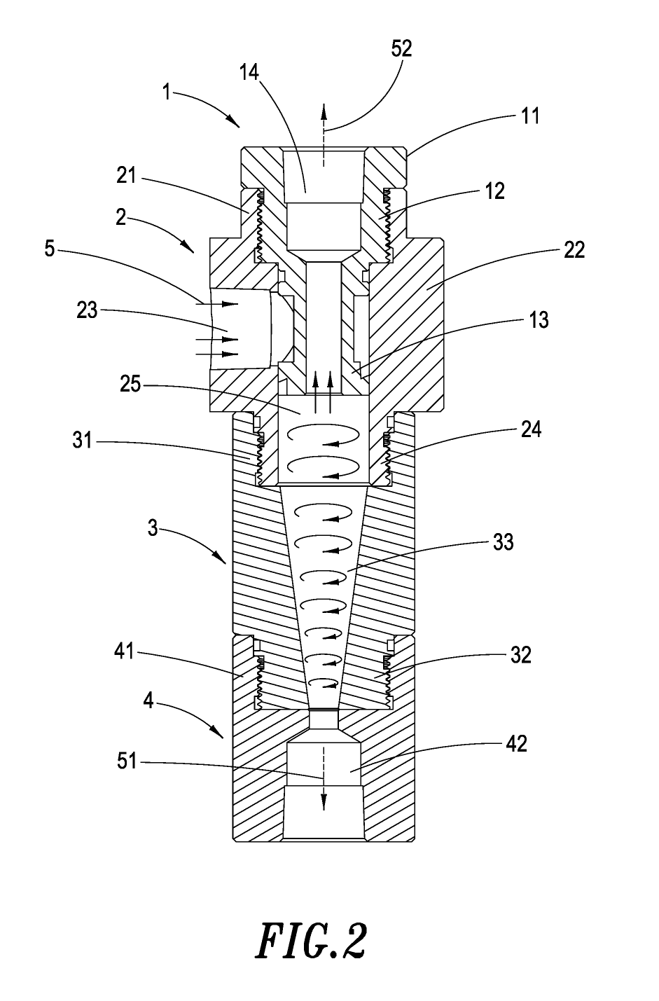

In the actual operating status, as shown in FIG. 2, after the top flow guiding assembly 1 is locked with the water inlet flow guiding assembly 2, the position of the water inlet opening 23 corresponds to the positions of the spiral flow guiding grooves 132 of the spiral flow guiding column 13. Thus, after the liquid 5 is injected into the water inlet opening 23 in a high pressure manner, the liquid 5 can be divided into a plurality of flows along the spiral flow guiding grooves 132 to convolute and move downwardly into the third through channel 33.

Because the specific weights of heavier impurity components comprised by the liquid 5 are greater, the impurity components will continuously collide with the inner walls of the second through channel 25 and the third through channel 33 during the process of convoluting along the spiral flow guiding grooves 132. Hence, the liquid 51 with the impurity components will gradually separate from the liquid 52 without the impurity components. In addition, because the third through channel 33 is a channel structure with a wider upper end and a narrower lower end, the injected liquid will be influenced by the reduced bottom of the third through passage 33 so as to cause the liquid 51 with the impurity components to move downwardly and cause the liquid 52 without the impurity components to stay at the top. Thus, when more liquid 5 is injected, the liquid 52 without the impurity components will naturally convolute upwardly and successively pass the third through channel 33, the second through channel 25, and the first through channel 14. Finally, the top cover portion 11 outwardly discharges the liquid 52 without the impurity components.

In addition, in the above operation, the existence of the spiral flow guiding grooves 132 are mainly used to cause the liquid 5 to be divided and convolute. The more bends the spiral flow guiding grooves 132 have, the easier the liquid 5 is divided into a plurality of flows, so that the separated impurity components are smaller. Hence, the purpose of effectively separating impurity components can be achieved by designing the shapes of the tilted ribs 131 so as to change the number of the bends and the sizes of the channels of the spiral flow guiding grooves 132.

Furthermore, because the specific weight of the liquid 51 with the impurity components is greater, the liquid 51 will flow downwardly into the fourth through channel 42. Then, the bottom portion of the impurity flow guiding assembly 4 may further be connected to at least one conduit and is configured to outwardly discharge the liquid with the impurity components through the conduit.

Compared with other conventional techniques, the advantages of the centrifugal filter provided by the present invention are as follows:

(1) The present invention can filter shreds or other impurities in the coolant via a device before the coolant enters the motor so as to prevent the motor from being damaged by shreds and other impurities.

(2) The spiral flow guiding grooves and the channel structure with a wider upper end and a narrower lower end of the centrifugal filter of the present invention can cause the impurity components having greater specific weights to naturally sink and cause the clean water to be discharged upwardly so as to prevent the motor connected to the centrifugal filter from being damaged by shreds and other impurities in the liquid.

Note that the specifications relating to the above embodiments should be construed as exemplary rather than as limitative of the present disclosure. The equivalent variations and modifications on the structures or the process by reference to the specification and the drawings of the disclosure, or application to the other relevant technology fields directly or indirectly should be construed similarly as falling within the protection scope of the disclosure.

What is claimed is:

1. A centrifugal filter, at least comprising:
a top flow guiding assembly having a top cover portion at a top portion, wherein the top cover portion downwardly forms a first screw connection column, and the first screw connection column downwardly forms a spiral flow guiding column, and a surface of the spiral flow guiding column has a plurality of spiral flow guiding grooves, and the top flow guiding assembly has a first through channel therein capable of passing through the top flow guiding assembly;
a water inlet flow guiding assembly having a first screw connection portion at a top portion and capable of being screwingly connected to the first screw connection column, wherein the screw connection portion has a screw connection wall surface therein, and the screw connection portion downwardly has a water inlet portion, and a sidewall surface of the water inlet portion has a water inlet opening thereon capable of passing through an inner portion of the water inlet portion, wherein the water inlet portion downwardly forms a second screw connection column, and the water inlet flow guiding assembly has a second through channel therein capable of passing through the water inlet flow guiding assembly;
a recessed flow guiding assembly having a second screw connection portion at a top end and capable of being screwingly connected to the second screw connection column, wherein a bottom end of the recessed flow guiding assembly has a third screw connection column, and an inner portion of the recessed flow guiding assembly has a third through channel capable of passing through the recessed flow guiding assembly, wherein the third through channel is a channel structure with a wider upper end and a narrower lower end;
an impurity flow guiding assembly having a third screw connection portion at a top end and capable of being screwingly connected to the third screw connection column, wherein an inner portion of the impurity flow guiding assembly has a fourth through channel capable of passing through the impurity flow guiding assembly, wherein a liquid entering from the water inlet opening is capable of convoluting and moving downwardly along the spiral flow guiding grooves into the third through channel, and a heavier impurity component comprised by the convoluting liquid flows downwardly to the fourth through channel due to the channel structure with the wider upper end and the narrower lower end of the third through channel, and finally the top cover portion outwardly discharges the liquid without the impurity component after the liquid without impurity component passes the third through channel, the second through channel, and the first through channel from the bottom to the top.

2. The centrifugal filter according to claim 1, wherein a bottom portion of the impurity flow guiding assembly is further capable of being connected to at least one conduit and is configured to outwardly discharge the heavier impurity component comprised by the liquid through the conduit.

3. The centrifugal filter according to claim 1, wherein the liquid entering from the water inlet opening is capable of being injected in a high pressure manner, such that the liquid is capable of convoluting and moving downwardly along the spiral flow guiding grooves into the third through channel.

4. The centrifugal filter according to claim 1, wherein after the top flow guiding assembly is locked with the water inlet flow guiding assembly, the water inlet opening corresponds to positions of the spiral flow guiding grooves of the spiral flow guiding column, such that the liquid entering from the water inlet opening is guided by the spiral flow guiding grooves so as to convolute and move downwardly along the spiral flow guiding grooves into the third through channel.
